(19) United States
(12) Patent Application Publication
(10) Pub. No.: US 2025/0187038 A1
(43) Pub. Date: Jun. 12, 2025

(54) Package Conveyor System and Method

(71) Applicant: CHEWY, INC., Plantation, FL (US)

(72) Inventors: Tim Foley, Woburn, MA (US); Gregorio Landeros Aranda, Woburn, MA (US); Carlos Fitts, Minneapolis, MN (US); Amelia Smith, Woburn, MA (US); Olivia McCafferty, Woburn, MA (US); Colin Dignam, Woburn, MA (US); Matthew Repetto, Woburn, MA (US); Akshit Garg, Woburn, MA (US); Marcus Maceyko, Woburn, MA (US); Raj Tejas Suryaprakash, Bellevue, WA (US); Luke Mehring, Woburn, MA (US); Scott Herscher, Minneapolis, MN (US); Jessica Cano, Woburn, MA (US); Venkata Siva Naga Chaitanya Chunduru, Woburn, MA (US)

(73) Assignee: CHEWY, INC., Plantation, FL (US)

(21) Appl. No.: 18/969,970

(22) Filed: Dec. 5, 2024

Related U.S. Application Data
(60) Provisional application No. 63/607,344, filed on Dec. 7, 2023.

(51) Int. Cl. B07C 1/00; B07C 3/08; B65G 47/28; G06V 10/774; G06V 20/52

(52) U.S. Cl. CPC B07C 1/00; B07C 3/08; G06V 10/774; G06V 20/52; B65G 47/28; B65G 2203/0216; G06V 2201/06

(57) ABSTRACT

A method of automatically diverting products from a shipping lane on a package conveyor system using a package sorter. One or more computing devices communicatively coupled to a network receives a plurality of digital images of products, generates an anomalous data set and a non-anomalous data set therefrom, and trains a machine learning model using the anomalous data set and the non-anomalous data set. Digital image are received of a target product traveling on the conveyor system. Prior to the target product reaching the package sorter, the trained machine learning model determines that the target product is an anomalous product. A command signal is delivered to the package sorter to cause the package sorter to divert the anomalous product from the shipping lane.

### CROSS-REFERENCE TO RELATED APPLICATIONS

This application claims the benefit of U.S. Provisional Patent Application No. 63/607,344 filed Dec. 7, 2023 entitled “Package Conveyer System and Method”, which is incorporated by reference herein in its entirety.

### TECHNICAL FIELD

The present disclosure generally relates to systems and methods for operating a conveyor system in a fulfillment center including diverting packaged products along a package conveyor and, in some embodiments, identifying anomalous products along a package conveyor and diverting those products accordingly.

### SUMMARY

In one embodiment there is a method of automatically diverting products from a shipping lane on a package conveyor system using a package sorter, the method including, at one or more computing devices communicatively coupled to a network: receiving a plurality of digital images of products; based on the plurality of digital images, generating an anomalous data set and a non-anomalous data set; training a machine learning model using the anomalous data set and the non-anomalous data set; receiving from an image capture device a digital image of a target product traveling on the conveyor system; prior to the target product reaching the package sorter, determining, via the trained machine learning model, that the target product is an anomalous product; and delivering a command signal to the package sorter to cause the package sorter to divert the anomalous product from the shipping lane.

In some embodiments, the conveyor system further includes a conveyor gapper and the method further includes causing the conveyor gapper to cooperate with the image capture device to ensure that the digital image of the target product does not reflect an adjacent package. In some embodiments, the one or more computing devices includes a local computing device coupled through a local area network to the image capture device and a remote computing device coupled through a wide area network to the local computing device and wherein the determining, via the trained machine learning model is performed at the local computing device and the training the machine learning model is performed at the remote computing device.

In some embodiments, determining that target product is an anomalous product occurs in a timeframe of: a) less than about 2 seconds from the target product reaching the package sorter along the conveyor; b) less than about 5 seconds from the target product reaching the package sorter along the conveyor; c) from about 2 seconds to about 5 seconds of the target product reaching the package sorter along the conveyor system; d) from about 1 second to about 2 seconds of the target product reaching the package sorter along the conveyor system; or c) less than about 1 second from the target product reaching the package sorter along the conveyor. In some embodiments, determining the target product is an anomalous product further includes calculating a confidence score representative of a severity of anomalies present on the target product.

In some embodiments, the method further includes, after diverting the target product from the shipping lane, receiving at the computing device a diverting digital image of the target product, and delivering a command signal to the package sorter to cause the package sorter to direct the target product to the shipping lane. In some embodiments, the method further includes receiving from the image capture device a digital image of a second target product, prior to the second target product reaching the package sorter, determining, via the trained machine learning model, that the second target product is a non-anomalous product, delivering a command signal to the package sorter to cause the package sorter to direct the non-anomalous product to the shipping lane.

In some embodiments, the method further includes calculating a confidence score representative of a lack of anomalies present on the second target product. In some embodiments, the anomalous product is characterized by defective seal. In some embodiments, the image capture device is configured to scan the target product for a container ID and capture the digital image of the target product for determining an anomaly status of the target product. In some embodiments, the method further includes after diverting the target product from the shipping lane, transporting the diverted target product to a position upstream of the package sorter along the package conveyor system, causing the image capture device to scan the diverted target product, overwriting an anomalous product designation for the diverted target product with a non-anomalous designation.

In another embodiment there is a system or automatically diverting products from a shipping lane, the system including a package conveyor system including a shipping lane downstream of a package sorter, the package conveyor configured to transport products to the package sorter, and one or more computing devices communicatively coupled to a network. The one or more computing devices are configured to receive a plurality of digital images of products, based on the plurality of digital images, generate an anomalous data set and a non-anomalous data set, train a machine learning model using the anomalous data set and the non-anomalous data set, receive from an image capture device a digital image of a target product traveling on the conveyor system, prior to the target product reaching the package sorter, determine, via the trained machine learning model, that the target product is an anomalous product, and deliver a command signal to the package sorter to cause the package sorter to divert the anomalous product from the shipping lane.

In some embodiments, the conveyor system further includes a conveyor gapper and the one or more computing devices are configured to cause the conveyor gapper to cooperate with the image capture device to ensure that the digital image of the target product does not reflect an adjacent package. In some embodiments, the one or more computing devices includes a local computing device coupled through a local area network to the image capture device and a remote computing device coupled through a wide area network to the local computing device and wherein the local device is configured to determine, via the trained machine learning model that the target product is an anomalous product and the remote computing device is configured to train the machine learning model.

In some embodiments, the one or more computing devices are configured to determine that target product is an anomalous product within a timeframe of: a) less than about 2 seconds from the target product reaching the package sorter along the conveyor; b) less than about 5 seconds from the target product reaching the package sorter along the conveyor; c) from about 2 seconds to about 5 seconds of the target product reaching the package sorter along the conveyor system; d) from about 1 second to about 2 seconds of the target product reaching the package sorter along the conveyor system; or e) less than about 1 second from the target product reaching the package sorter along the conveyor.

In some embodiments, the one or more computing devices are further configured to calculate a confidence score representative of a severity of anomalies present on the target product. In some embodiments, the one or more computing devices are further configured to, after diverting the target product from the shipping lane, receive at the computing device a diverting digital image of the target product, and deliver a command signal to the package sorter to cause the package sorter to direct the target product to the shipping lane. In some embodiments, the one or more computing devices are further configured to receive from the image capture device a digital image of a second target product, prior to the second target product reaching the package sorter, determine, via the trained machine learning model, that the second target product is a non-anomalous product, and deliver a command signal to the package sorter to cause the package sorter to direct the non-anomalous product to the shipping lane.

In some embodiments, the one or more computing devices are further configured to calculate a confidence score representative of a lack of anomalies present on the second target product. In some embodiments, the anomalous product is characterized by a defective seal. In some embodiments, the image capture device is configured to scan the target product for a container ID and capture the digital image of the target product for determining an anomaly status of the target product. In some embodiments, the one or more computing devices are further configured to after diverting the target product from the shipping lane, transport the diverted target product to a position upstream of the package sorter along the package conveyor system, cause the image capture device to scan the diverted target product, overwrite an anomalous product designation for the diverted target product with a non-anomalous designation.

### BRIEF DESCRIPTION OF THE DRAWINGS

The following detailed description of embodiments of the system and method of diverting products from a shipping lane on a package conveyor, will be better understood when read in conjunction with the appended drawings of an exemplary embodiment. It should be understood, however, that the invention is not limited to the precise arrangements and instrumentalities shown.

In the drawings:

FIG. 1 is a block diagram illustrating a system for diverting products from a shipping lane on a package conveyor in accordance with an exemplary embodiment of the present disclosure;

FIG. 2 is a block diagram illustrating digital images used to train a machine learning model via the system of FIG. 1;

FIG. 3 is a chart illustrating digital images of products having varying severities of anomalies in accordance with an exemplary embodiment of the present disclosure;

FIG. 4 is a block diagram illustrating a conveyor system included in the system of FIG. 1;

FIG. 5 is a time lapse illustration of a target product traveling along the conveyor system of FIG. 4;

FIG. 6 is a perspective view of an image capture device in accordance with an exemplary embodiment of the present disclosure;

FIG. 7 is a perspective view of an image capture device in accordance with another exemplary embodiment of the present disclosure;

FIG. 8 is a block diagram illustrating a use case examples of the system of FIG. 1;

FIG. 9 is a block diagram illustrating a use case examples of the system of FIG. 1;

FIG. 10 is a block diagram illustrating a use case examples of the system of FIG. 1; and

FIG. 11 is a flowchart illustrating a method for diverting products from a shipping lane in accordance with an exemplary embodiment of the present disclosure.

### DETAILED DESCRIPTION

Package conveyors are commonly used to transport and sort products along various routes and branches of a conveyor assembly. In fulfillment centers, package conveyors are commonly used to divert packaged products to respective shipping docks at which the packaged products are loaded onto a transport vehicle (e.g., automobile, airplane) and shipped out. However, in some instances the packaged products may not be desirable for shipping. For example, the shipping container for the product may be damaged (e.g., torn, ripped, dented), defective (e.g., not scaled, missing adhesive) or otherwise anomalous. As the number of packages along the package conveyors increases and/or the rate of travel increases, challenges arise to the detecting and diverting of those anomalous products so they can be repaired and introduced to the shipping lane. there is a need to provide a system and/or method for automatically identifying and diverting anomalous packaged products from a shipping lane along a package conveyor.

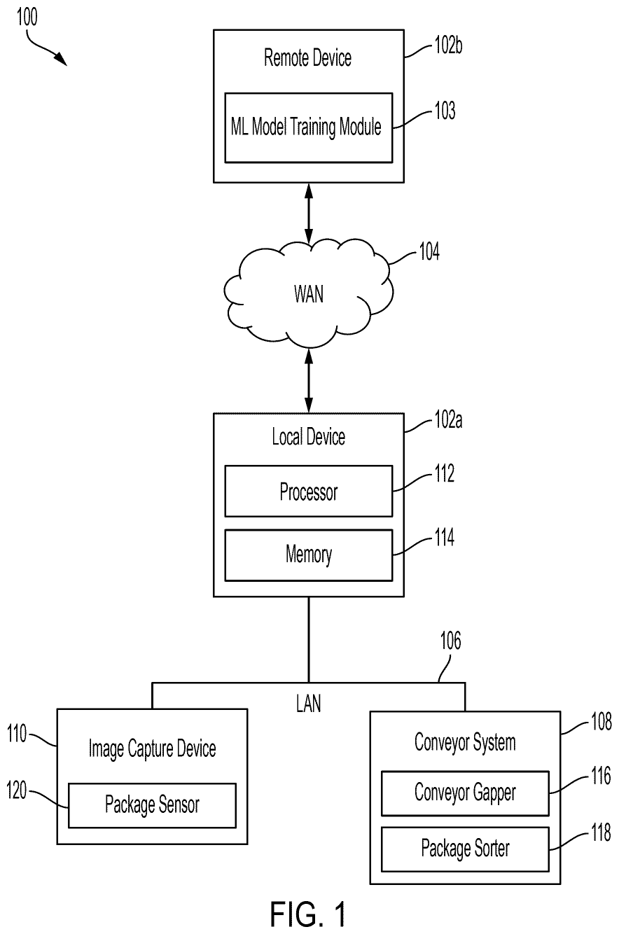

Referring to the drawings in detail, wherein like reference numerals indicate like elements throughout, there is shown in FIG. 1 a system for diverting products from a shipping lane along a package conveyor, generally designated 100 and referred to as system 100 herein, in accordance with an exemplary embodiment of the present invention. The system 100 may be configured to automatically determine whether a product is anomalous. Based on that detection, the package may be automatically routed to a shipping lane or to a triage operation area. In some embodiments, the system 100 is configured to analyze products for anomalies as they are transported along a package conveyor. One advantage to such a system is to reduce the occurrence of bottlenecks and/or stops along the package conveyor. In some embodiments, the system 100 is configured to automatically divert anomalous products from a shipping lane to a triage location and automatically reintroduce the product into the shipping lane following triage operations. In some embodiments, the system 100 is configured to automatically determine the severity of any anomalies present on a product and automatically determine where the product should be routed based on that severity. For example, multiple rectification locations may be operational to receive anomalous packages with the characteristic of the anomaly determining which of the multiple rectification locations the package is routed to.

In one embodiment, the system 100 includes one or more computing devices, having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

There is shown in FIG. 1 a block diagram illustrating an implementation of the system 100. While some example features are illustrated, various other features have not been illustrated for the sake of brevity and so as not to obscure pertinent aspects of the example embodiments disclosed herein. In some embodiments, the system 100 includes one or more computing devices (e.g., local device 102a, remote device 102b) communicatively coupled to a network (e.g., wide area network 104 (WAN), local area network (LAN) 106). In some embodiments, the system 100 includes a package conveyor system 108 for transporting products and an image capture device 110 configured to capture images of products transported along the conveyor system 108.

Networks 104 and/or 106 may be representative of any suitable type, including, but not limited to, individual connections via the Internet, such as cellular or Wi-Fi networks. In some embodiments, networks 104 and/or 106 may connect terminals, services, computing devices, external devices using direct connections, such as, but not limited to, radio frequency identification (RFID), near-field communications (NFC), Bluetooth™, low-energy Bluetooth™ (BLE), Wi-Fi™, Zigbee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security. Networks 104, 106 may include any type of computer networking arrangement used to exchange data. For example, networks 104 and/or 106 may be representative of the Internet, a private data network, virtual private network using a public network and/or other suitable connection(s) that enables components in system 100 to send and receive information between the components of system 100.

The local device 102a may be communicatively coupled to the conveyor system 108 and/or image capture device 110. For example, the local device 102a may be in communication with the conveyor system 108 and image capture device 110 via LAN 106. In some embodiments, the local device 102a is configured to determine whether products being transported along a conveyor system 108 are anomalous or not and cause the products to be diverted away from a shipping lane or routed to the shipping lane, as discussed in more detail below. The local device 102a may include a processor 112 and a memory 114. The memory 114 may be a non-transitory computer readable storage medium. In some embodiments, the processor 112 may be configured to execute a machine learning (ML) model stored in memory 114 on digital images of products received from the image capture device 110. The remote device 102b may be communicatively coupled to the local device 102a (e.g., via WAN 104) and configured to generate a trained ML model. In some embodiments, the remote device 102b includes a ML model training module 103 configured to train a ML model based on one or more datasets, as discussed in more detail below. In some instances, the remote device 102b may be configured to transmit a trained ML model to the local device 102a to be stored in memory 114. In some embodiments, the local device 102a and remote device 102b may be a single computing device or a system of networked computing devices.

In some embodiments, the conveyor system 108 is configured to transport products along conveyor belts to a target destination. For example, a conveyor system 108 for use with the system and methods of the present disclosure includes powered conveyor belts for transporting products to one or more shipping lanes and/or triage locations. In some embodiments, the conveyor system 108 includes a conveyor gapper 116 configured to increase the distance between adjacent products being transported along a conveyor belt. In other embodiments, the conveyor system 108 may not include a conveyor gapper 116. In some embodiments, the conveyor system 108 may include a package sorter 118 configured to transfer products from one conveyor belt to a conveyor belt branching therefrom. In some embodiments, the conveyor system 108 includes a plurality of package sorters 118 for routing products to one or more branches of a conveyor belt. For sake of brevity, aspects of the present disclosure will be described in reference to the conveyor system 108 including a single conveyor gapper 116 and package sorter 118. However, it should be understood that the conveyor system 108 may include any number of conveyor gappers 116 and/or package sorters 118 in accordance with the complexity of and/or number of branching conveyor belts. For example, as the number of shipping lanes increases, the number of branching conveyor belts may increase, which may increase the number of package sorters 118 required to route products accordingly.

The image capture device 110 may be configured to capture digital images of products while the products are traveling on the conveyor system 108. The image capture device 110 may be positioned at a location along a conveyor belt of the conveyor system 108 and configured to capture digital images of products proximate that location. The image capture device 110 may include a package sensor 120 configured to detect the presence of an object (e.g., product) travelling on the conveyor system 108 and cause the image capture device 110 to capture a digital image upon detection of the object. For example, in response to the package sensor 120 detected a product, the package sensor 120 may be configured to generate a signal to cause the image capture device 110 to capture a digital image of the product. The package sensor 120 may be one or more of a proximity sensor, a trigger sensor, a break-beam sensor and/or any other suitable sensing device for detecting the presence of an object. In some embodiments, the image capture device 110 is a high dynamic range (HDR) image capture device configured to generate HDR digital images.

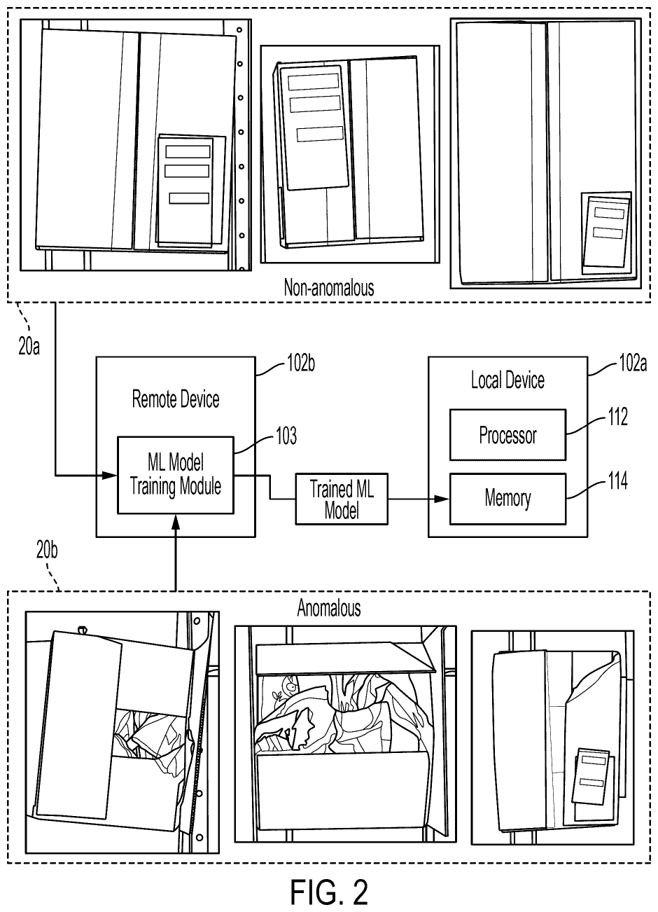

Referring to FIG. 2, in some embodiments, the system 100 is configured to train an ML model to identify anomalous products and non-anomalous products. The system 100 may be configured to receive a plurality of digital images of products and generate an anomalous data set and a non-anomalous data set for use in training the ML model. For example, and as illustrated in FIG. 2, there may be a plurality of digital images 20a corresponding to non-anomalous products and a plurality of digital images 20b corresponding to anomalous products. The digital images 20a may include a plurality of digital images of different products classified as being non-anomalous, or normal. As illustrated in FIG. 2, the digital images 20a of non-anomalous products include a depiction of intact containers, labels applied thereto and orderly seals (e.g., adhesives, tape). The digital images 20b of anomalous products include a depiction of products having defectively sealed containers, dunnage leaking therethrough, and in some instances are devoid of any labels. The images shown in FIG. 2 are for illustrative purposes only and in some instances different images and/or numbers thereof may be used to train an ML model. The anomalies or lack thereof used to categorize products as either anomalous or non-anomalous as discussed herein are for illustrative purposes only and in other implementations different anomalies or the lack thereof may be used to define anomalous and non-anomalous products.

In some embodiments, the plurality of digital images 20a and 20b may be used to generate anomalous package data sets and non-anomalous package data sets. The digital images 20a and 20b may be transmitted to the ML model training module 103 of the remote device 102b to generate an anomalous package data set and a non-anomalous package data set. In some embodiments, the digital images 20a and 20b may be sorted and/or categorized into anomalous package data sets and non-anomalous package data sets. The anomalies appearing in the anomalous digital images 20b may be identified and categorized accordingly such that the ML model training module 103 may be trained to identify and categorize different anomalies. For example, the dunnage leakages appearing in the digital images 20b may be identified and categorized for digital images in which they occur such that the ML model training model 103 may train the ML model to identify and categorize similar anomalies. This process may be repeated for any number of images and/or anomalies such that the trained ML model may identify and/or categorize anomalies appearing in products. In some embodiments, anomalies may include, but are not limited to: dunnage leakage, gaps, defective seals, dents, tears, deformations, and/or obscured labels.

In some embodiments, a plurality of digital images 20a of products categorized as non-anomalous are input to the ML model training module 103 in order to produce a trained ML model configured to identify non-anomalous products. The non-anomalous digital images 20a may be identified and categorized in generally the same manner such that the ML model training module 103 may be trained to identify and categorize non-anomalous, or normal, products. For example, a desired sealing and/or unobstructed label may be identified and categorized for digital images included in the plurality of non-anomalous digital images 20a. This process may be repeated for any number of images and/or examples of normal products such that the trained ML model may identify and/or categorize non-anomalies appearing in products.

In some embodiments, the remote device 102b is configured to transmit the trained machine learning model to the local device 102a. For example, in response to generating the trained machine learning model using the anomalous and non-anomalous product data sets as discussed above, the remote device 102b may transmit the trained ML model to the local device 102a where it may be stored in a local storage device and/or memory 114. The local device 102a may be configured to execute the trained ML model on digital images of products to identify and/or categorize any anomalies or lack thereof. In some instances, multiple ML models may be trained and transmitted to the local device 102a for storage and execution. In some embodiments, executing the trained ML model local improves processing time at the local operation. In some embodiments, the local device 102a is configured to execute more than one trained ML model on a digital image. For example, the local device 102a may execute a shadow ML model and a primary ML model on a single digital image. A shadow model may refer to an ML model configured to make a determination and/or prediction (e.g., a determination of anomalies or lack thereof) that is not input into the system 100 and/or that does not impact the operations of the system 100. A primary model may refer to an ML model that also is configured to make some determination and/or prediction, which is input into the system 100 and/or impacts the operations of the system 100. For sake of brevity, the ML models discussed herein are primary models, however it should be understood that shadow models may be executed in any of the processes and/or systems discussed herein. In some embodiments, the local device 102a is configured to execute at least two trained ML models each configured to make different determinations and/or predictions. For example, a first trained ML model may be configured to identify dunnage leakages whereas a second trained ML model may be configured to identify errors in a printed label applied to a product. For sake of brevity though, only a single trained ML model is discussed herein.

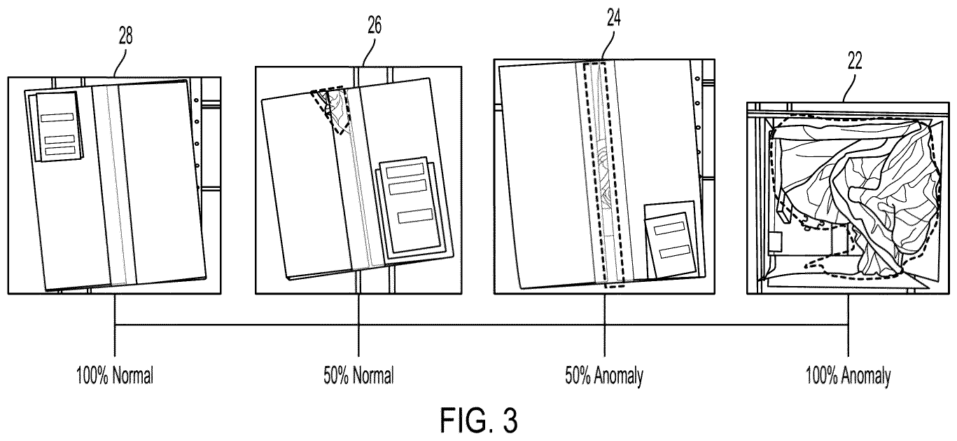

Referring to FIG. 3, in some embodiments, the system 100 is configured to calculate a confidence score representative of how likely an anomalous or non-anomalous a product was correctly designated as such by the trained ML model. As discussed above, the trained ML model is configured to designate products as anomalous or non-anomalous based on anomalies identified in digital images of the products. The number and/or severity of anomalies identified by the trained ML model varies across digital images of different products and the likelihood of a correct designation as anomalous/non-anomalous may vary accordingly. In some embodiments, the trained ML model is configured to calculate a confidence score that is representative of the severity of anomalies present on a product based on a digital image of the product. In some embodiments, the system 100 is configured to automatically divert products that are designated as anomalous based on the confidence score (e.g., that and are within a predetermined confidence score range).

FIG. 3 depicts four exemplary digital images 22, 24, 26, 28 of products and the corresponding confidence scores calculated by the trained ML model. In some embodiments, confidence scores determined via the trained ML model range from 100% anomaly to 100% normal. A 100% anomaly confidence score may be representative of a digital image of a product anomalies identified via the trained ML model severe enough that the anomalous designation of that product is determined to be 100% accurate by the trained ML model. A 100% normal confidence score may be representative of a product having no anomalies detected by the trained ML model and designated as a non-anomalous product. Determining a confidence score relating to the severity of anomalies, or lack thereof, may enable the system 100 to optimize diversion of products from a shipping lane according to a confidence score threshold that may be edited or altered as desired.

In some embodiments, the ML model is trained to identify the type, size and/or number of anomalies appearing in digital images of products and based on the size and/or number of those instances, calculate a confidence score representative of the severity of anomalies present on the product. For example, and as illustrated in FIG. 3, the trained ML model when executed on the digital image 22 results in a confidence score of 100% anomaly. In this example, the 100% anomaly confidence score is a result of the trained ML model determining that there are multiple instances of anomalies (e.g., defective seal, dunnage leakage, no visible label) and that the anomalies comprise a substantial portion of the digital image 22. As illustrated in FIG. 3, the area outlined in dotted lines appearing in the digital image 22 is representative of areas of the digital image 22 that the trained ML model identified as a dunnage leakage anomaly. Further to this example, the trained ML model identifies in digital image 22 that no label is visible and that no container seal is visible. In response to identifying the portions of the digital image 22 depicting a dunnage leaking, the presence of a defective seal, and the lack of a label, the trained ML automatically calculates a 100% anomaly confidence score. In this example, the 100% anomaly confidence score indicates that the designation of the product depicted in the digital image 22 as an anomalous product based on the severity of anomalies identified therein is 100% correct.

The trained ML model, when executed on the digital image 24, resulted in a confidence score of 50% anomaly. In some embodiments, a 50% anomaly is representative of an anomalous designation of a product via the trained ML model that is calculated as 50% likely to be an accurate designation. The 50% anomaly confidence score in reference to digital image 24 is associated with the identification of minor anomalies (e.g., low severity anomalies). In some embodiments, products having minor anomalies are not diverted from a shipping lane by the system 100 based on the anomaly confidence score. The outlined area in the digital image 24 illustrates a gap anomaly in the product container identified by the trained ML model. The trained ML model may be configured to determine the severity of identified anomalies based on their size relative to the size of the package and/or the digital image. For example, the trained ML model determined that the area outlined in digital image 24 comprises less than half of the digital image 24 resulting in the determined severity to be low. The size of the identified anomaly, in part, results in the calculation of a 50% anomaly confidence score by the trained ML model.

Additionally, the trained ML model may be configured to determine the confidence score based on the lack of identified anomalies. For example, in the digital image 24 the only anomaly identified is the container gap anomaly as outlined. Accordingly, the trained ML model calculates the 50% anomaly confidence score for the digital image 24 based at least in part on the lack of other identified anomalies. The confidence score for the digital image 24 may indicate that the product shown therein is less anomalous and/or has less sever anomalies than the product shown in digital image 22.

The trained ML model when executed on the digital image 26 resulted in a 50% normal confidence score. The 50% normal confidence score is representative of a determination via the trained ML model that the designation of the product depicted in the digital image 26 as non-anomalous is 50% likely to be correct. The trained ML model identifies a container deformation anomaly, as outlined in the dotted lines, in the digital image 26. However, the severity of that anomaly determined by the trained ML model is lower than the severity of the gap anomaly identified in the digital image 24 resulting, at least in part, in the trained ML model calculating the 50% normal confidence score. Additionally, the trained ML model identifies no additional anomalies present in the digital image 24, which is further factored into the confidence score calculation.

The trained ML model when executed on the digital image 28 resulted in a 100% normal confidence score. The 100% normal confidence score is representative of a determination via the trained ML model that the designation of the product depicted in the digital image 28 as non-anomalous is 100% likely to be correct. When executed on the digital image 28, the trained ML model identifies no anomalies resulting in the calculation, via the trained ML model, of a 100% normal confidence score.

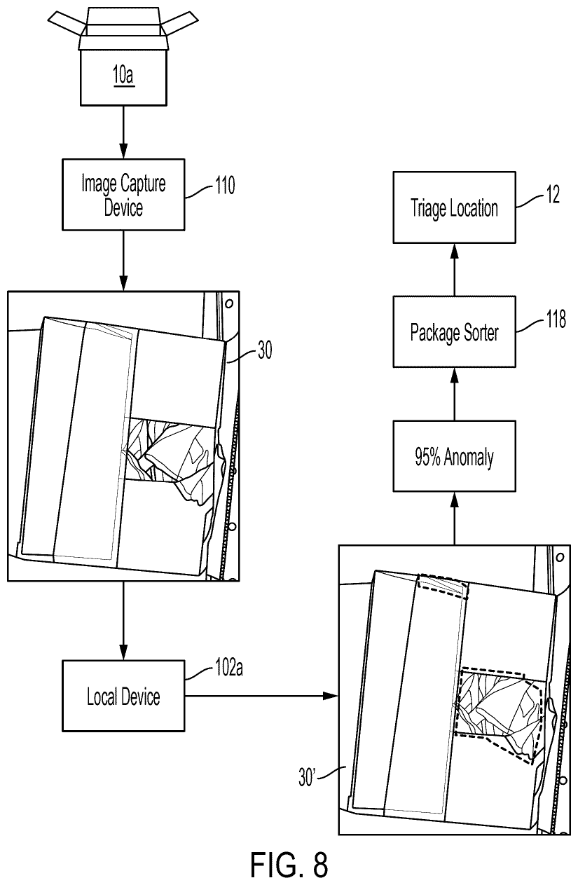

In some embodiments, the trained ML model is configured to attribute weighted values to different types of anomalies or the lack thereof when calculating the confidence score. For example, the container gap anomaly identified in the digital image 24 may be attributed a higher weighted value than the package deformation anomaly identified in the digital image 26. The identification of the two types of anomalies resulted, at least partially, in the trained ML model assigning the digital image 24 to be anomalous with a 50% anomaly confidence score and the digital image 26 to be non-anomalous with a 50% normal confidence score. In some embodiments, the system 100 is configured to enable the weight attributed to different types of anomalies to be edited as desired. For example, while the package deformation anomaly was attributed a lower weight than the container gap anomaly in the above example, in other instances the container gap anomaly may be attributed a lower weight than the package deformation anomaly. As another example, a higher weight is attributed to a dunnage leakage anomaly detected at a target product than a shipping label error detected at the same target product. Further to this example, the trained ML model assigns to the target product, or the digital image thereof, a confidence score of 90% anomaly based on the detected dunnage leakage and label errors, where the detected dunnage leakage contributes more to the confidence score value than the detected label error. The confidence score values and the corresponding digital images 22, 24, 26, and 28 shown in FIG. 3 and discussed above are for illustrative purposes only. The system 100 may be configured to determine confidence scores ranging from 100% normal to 100% anomaly for a variety of products and digital images thereof, as illustrated in FIG. 3 and as discussed in more detail below with reference to FIGS. 8-10.

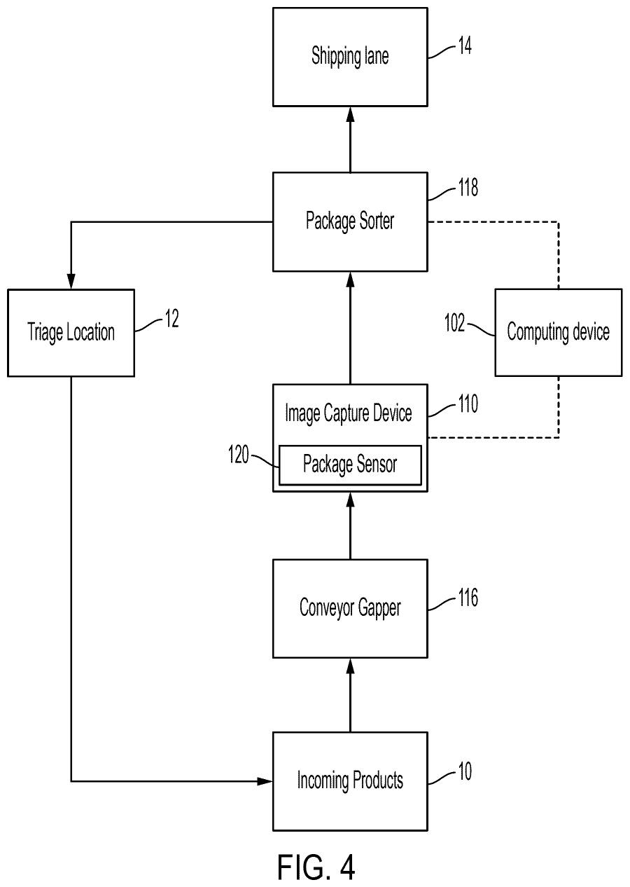

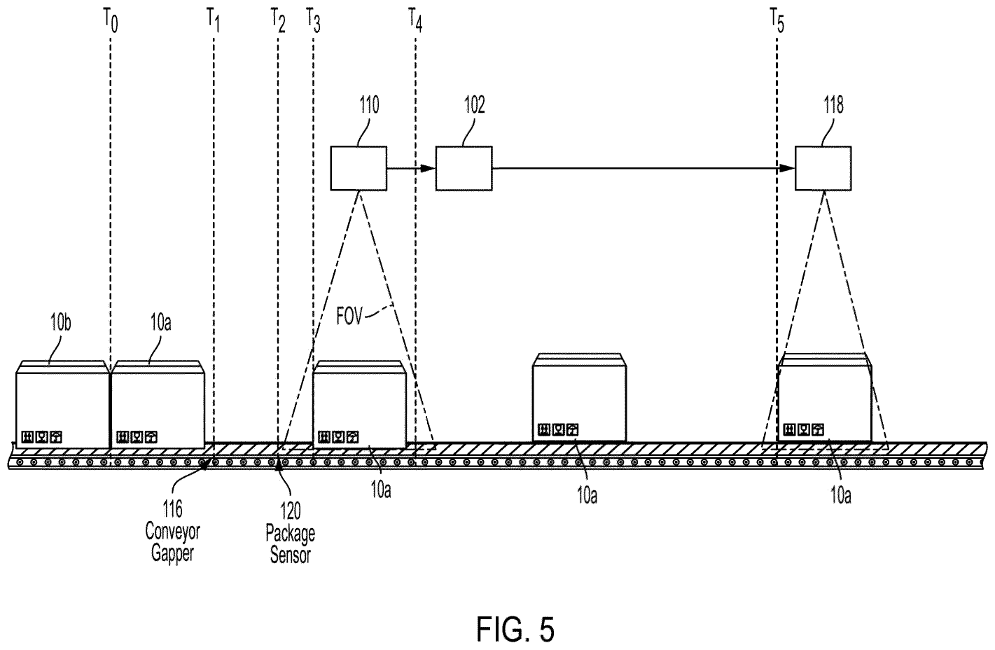

Referring to FIGS. 4-5, one or more components of the system 100 may be positioned along a conveyor belt included in the conveyor system 108 such that the system 100 may identify anomalous products and based on the identification divert them from a shipping lane. The arrows in FIG. 4 may represent conveyor belts included in the conveyor system 108 and the direction of the arrows may represent the direction of products being transported along the conveyor belts. For example, products may be transported from a point on the conveyor proximate the image capture device 110 downstream to the package sorter 118. Upstream and downstream as referenced herein may generally refer to locations along the conveyor belt in relation to components of the system 100. For example, the conveyor gapper 116 may be located on the conveyor upstream of the image capture device 110 and downstream of incoming products 10. In some embodiments, the conveyor system 108 may include a main or central conveyor belt generally represented by the arrows extending between the incoming products 10, conveyor gapper 116, image capture device 110 and package sorter 118. The remaining arrows may represent conveyor belts branching from the main conveyor belt. Incoming products 10 may include products transported along the main conveyor belt that are upstream of the conveyor gapper 116 and/or image capture device 110.

Incoming products 10 may be transported along the main conveyor belt to the conveyor gapper 116 which is configured to space adjacent products from one another. For example, and as illustrated in FIG. 5, at time T₀ a target product 10a upstream of the conveyor gapper 116 is traveling closely to product 10b along the conveyor belt. At a time T₁ occurring after the time T₀ the target product 10a reaches the conveyor gapper 116. In response to the target product 10a reaching the conveyor gapper 116 generally at time T₁, the conveyor gapper 116 causes a distance between the target product 10a and the adjacent product 10b to be increased. In some embodiments, the conveyor gapper 116 includes powered conveyor belts or rollers having a different rotation per minute (RPM) than other belts or rollers included in the gapper 116 or adjacent thereto. When the target product 10a is gripped by the conveyor belt of the gapper 116 the velocity of the target product 10a is altered (e.g., increased) creating a gap between the two products 10a, 10b. Conveyor gapper 116 may be any suitable type of gapping conveyor system or device and is not limited to the above-described example.

The system 100 may be configured to transport a product from the conveyor gapper 116 downstream to the image capture device 110 and cause the image capture device 110 to generate a digital image of the product. In some embodiments, the conveyor gapper 116 is configured to cooperate with the image capture device 110 to ensure that a digital image of a product does not reflect an adjacent package (e.g., a packaged product) in a manner that would degrade system 100. For example, and referring to FIG. 5, the conveyor gapper 116 spaces the target product 10a from the adjacent product 10b such that only the target product 10a is within a field of view (FOV) of the image capture device 110. In some embodiments, the image capture device 110 is fixed in position relative to the conveyor system 108 such that the FOV of the image capture device 110 is fixed relative to conveyor system 108. The size of the FOV may be based at least partially on a largest product size. Products transported along the conveyor system 106 may be packaged in shipping containers having a size selected from one of a plurality of different sizes. Of the plurality of different sizes, the FOV may be sized to accommodate for the largest shipping container size. For example, if the largest size of a product is about 25″×17″×12″, the FOV may be sized such that the entirety of a product having those dimensions may be within contained within the FOV while a digital image of the product is generated by the image capture device 110. In some embodiments, the image capture device 110 may include one or more cameras and/or barcode scanners each of which may have an associated FOV.

In some embodiments, the package sensor 120 is configured to generate location data for a product traveling along a conveyor belt. For example, and as illustrated in FIG. 5, at a time T₂ occurring after the time T₁ the target product 10a reaches the package sensor 120 causing the package sensor 120 to generate location data for the target product 10a. The location data may be an electrical signal sent from the package sensor 120 to a processor or application specific integrated circuit (ASIC) included in the image capture device 110. In some embodiments, the location data is based on the location of the package sensor 120 relative to the conveyor system 108. For example, the location data generated by the package sensor 120 in FIG. 5 indicates that the target product 10a has reached the location at which the package sensor 120 is positioned.

In response to the location data being generated, the image capture device 110 may be configured to capture a digital image of the product. For example, at time T₃ the image capture device 110 generates a digital image of the target product 10a in response to the package sensor 120 detecting the product 10a at time T₂. The time T₃ may occur after the time T₂ based on the speed of the conveyor belt and/or the position of the FOV relative to the package sensor 120. For example, if the conveyor belt transporting the target product 10a causes the target product to move at 60 feet per minute, and the package sensor 120 is upstream of a focal center of the FOV by about one foot, then the image capture device 110 may be configured to capture the digital image of the product about one second after the package sensor 120 generates location data. In some embodiments, the package sensor 120 is located upstream of a camera and/or barcode scanner of the image capture device 110. In other embodiments, the package sensor 120 may be located downstream of a camera and/or barcode scanner of the image capture device such that the time at which the package sensor 120 detects a product and the time at which the image capture device 110 generates the digital image occur generally simultaneously.

In some embodiments, the system 100 is configured to determine a container ID of the product. The container ID may be a unique identifier (e.g., a unique value) associated with the product. The image capture device 110 may be configured to determine a container ID of the product at generally the same time at which the digital image of the product is generated. In some instances, the image capture device 110 includes a camera and a barcode scanner, the camera configured to generate the digital image of the product and the barcode scanner being configured to determine a container ID (e.g., a barcode value) for that product. For example, the product may be a packaged product contained within a shipping container (e.g., a cardboard box) having one or more labels including a barcode or other identifying indicia visible thereon. The barcode scanner may capture the unique barcode value.

In response to the digital image being captured, the image capture device 110 may be configured to transmit the digital image to the computing device 102. For example, and as illustrated in FIG. 5 at a time T₄ occurring after the time T₃, the image capture device 110 transmits the digital image of the target product 10a to the computing device 102 (e.g., local device 102a). In some embodiments, the image capture device 110 is configured to transmit the digital image as well as the unique product identifier (e.g., barcode value) to the computing device 102.

In response to receiving the digital image of the target product, the computing device 102 may be configured to determine, via the trained ML model, whether the product is anomalous or non-anomalous. In some embodiments, the computing device 102 is configured to determine whether the product is anomalous prior to the product reaching the package sorter 118. For example, and as illustrated in FIG. 5, it takes the target product 10a an amount of time generally equal to T₅−T₄ to reach the package sorter 118, where the time T₅ represents the time at which the target product 10a reaches the package sorter 118. The computing device 102 may be configured to, in an amount of time less than or equal to T₅−T₄, determine via the trained machine learning model, whether the target product 10a is an anomalous product. In some embodiments, the time T₅−T₄ is less than about 2 seconds. In some embodiments, the time T₅−T₄ is less than about 5 seconds. In some embodiments, the time T₅−T₄ is between about 2 seconds to about 5 seconds. In some embodiments, the time T₅−T₄ is between about 1 seconds to about 2 seconds. In some embodiments, the time T₅−T₄ is less than about 1 second. In some embodiments, the local device 102a executes the trained ML model on the digital image of the target product 10a and generates an assignment of that product to either anomalous or non-anomalous in a time less than or equal to T₅−T₄. In some embodiments, determining whether the target product 10a is anomalous via the local device 102a may reduce the processing time required to make the determination as compared to the remote device 102b. For example, transmitting a digital image of a product to the remote device 102b, executing the trained ML model at the remote device 102b thereon and then transmitting back the determination of anomalous or non-anomalous to the package sorter 118 may increase processing time by at least 50% as compared to the same processes being carried out via the local device 102a.

In some embodiments, the computing device 102 is configured to deliver a command signal to the package sorter 102 to cause the package sorter 118 to divert anomalous products from a shipping lane. The command signal may be representative of the determination of whether the target product 10a is anomalous. For example, in an instance where the computing device 102 determines the target product 10a is anomalous, the command signal indicates that the target product 10a is anomalous. In an instance where the computing device 102 determines the target product 10a is non-anomalous, the command signal indicates that the target product 10a is non-anomalous. In some embodiments, the determination of whether the target product 10a is anomalous is performed by the local device 102a and the command signal is generated by either the local device 102a or remote device 102b. For example, the local device 102a may determine via the trained ML model that the target product 10a is anomalous and transmit data to the remote device 102b indicating the same. The remote device 102b, in communication with the package sorter 118, generates the command signal and transmits it to the package sorter 118. In other embodiments, the local device 102a generates and transmits the command signal to the package sorter 118.

The package sorter 118 may be configured to receive products and route them to either 1) a triage location 12, or 2) an appropriate shipping lane 14. The triage location 12 may be a location at which anomalous products are routed by the package sorter 118. The shipping lane 14 may include one or more shipping lanes to which non-anomalous products are routed by the package sorter 118. The package sorter 118 may be configured to receive the command signal from the computing device 102 and route products according to the command signal. For example, in an instance where the command signal generated by the computing device 102 indicates that a product is anomalous, the package sorter 118 is configured to divert that product from the shipping lane 14. In some embodiments, diverting the product from the shipping lane 14 includes routing, via the package sorter 118, the product to the triage location 12. In an instance where the command signal indicates that a product is non-anomalous, the package sorter 118 is configured to transport the product to the shipping lane 14. Products received at the triage location 12 may be repaired either manually or via an automated triage device and reintroduced into the main conveyor belt upstream of the conveyor gapper 116. For example, a conveyor belt routes triaged products back into the incoming products 10 that is upstream of the conveyor gapper 116 such that the triaged products are routed to the shipping lane 14.

In some instances, products may be incorrectly assigned to be anomalous products and routed to the triage location 12. In such instances, it may be beneficial to quickly and easily transmit a digital communication to the system 100 indicating that the product was incorrectly determined as anomalous. In some embodiments, a triage location 12 may include an interactable signal transmitting device (e.g., a powered button, an interactable GUI element, a switch) communicatively coupled to at least one of the local device 102a and remote device 102b. When activated, the signal transmitting device may transmit a signal to the local and/or remote devices 102a, 102b indicating that the assignment of a product as anomalous via the trained ML model was incorrect. In some embodiments, the unique product identifier (e.g., product ID) for the incorrectly assigned product is automatically transmitted to the local device 102a and/or remote device 102b and electronically stored for later retrieval. The incorrectly assigned product may be transported along the conveyor belt back into the incoming products 10. By storing the unique ID of incorrectly assigned products, the digital images of those products may be manually and/or automatically retrieved at a later time and feedback to the ML training system such that the observable anomaly (e.g., no observable anomaly) and the corresponding anomaly score are used to improve training of the ML model. For example, the corresponding digital images may be introduced into the non-anomalous digital images 20a discussed in FIG. 2 and included in the training of the ML model.

In some embodiments, the command signal includes a container ID of the product to which it corresponds and the package sorter 118 is configured to route products based, at least in part, on the container ID of that product. As discussed above, the image capture device 110 may be configured to capture a container ID (e.g., a barcode value) of the target product 10a with the digital image thereof and transmit each to the computing device 102. The command signal transmitted to the package sorter 118 includes the container ID of target product 101 and an indication as to whether target product 10a is anomalous.

The package sorter 118 may be configured to determine the container ID of the target product 10a and automatically associate it with the corresponding command signal. For example, the package sorter 118 includes an image capture device configured to determine the barcode value for the target product 10a. The package sorter 118 in some embodiments, is configured to match the barcode value determined in this manner with the one included in the received command signal and route the target product 10a accordingly. In some embodiments, the package sorter 118 includes a diverting device and/or mechanism for displacing products transported along the conveyor system 108 to either the triage location 12 and/or the one or more shipping lanes 14. An image capture device included in the package sorter 118 may be located upstream of a diverting device and/or mechanism operably coupled thereto.

In some embodiments, the system 100 is configured to automatically route products that were previously diverted from a shipping lane 14 back to the shipping lane 14. In instances where the computing device 102 determines that a product is anomalous, the computing device 102 delivers the command signal to the package sorter 118 causing the package sorter 118 to divert that product from a shipping lane 14 as discussed above. In some embodiments, the computing device 102 stores a digital record of anomalous products as well as the container ID for those products in a storage device for later retrieval. The diverted anomalous product is automatically transported to a triage location 12 or any other location at which the anomalous product may be repaired. For example, a product determined as anomalous by the computing device 102 may have had a defective seal, causing it to be routed to triage location 14. Following successful triage operations of a diverted anomalous product, that product may be reintroduced into the incoming products 10 upstream of the conveyor gapper 116. The reintroduced product is transported upstream to the conveyor gapper 116 and to the image capture device 110 in generally the same manner as discussed above and may be routed to a shipping lane (e.g., because an image capture operation is suspended to allow the package to be so routed, because the image capture signal is ignored and/or because the image capture system indicates that the package is no longer anomalous).

The image capture device 110 may generate a digital image of the diverted product and determine the container ID of that product. For example, a target product 10a reintroduced upstream of the image capture device 110 results in the image capture device 110 generating a diverting digital image of the target product 10a including a determination of the container ID of that product. The system 100 may be configured to automatically compare the container ID of the diverted product to a digital record of container IDs for products that were determined to be anomalous. For example, the computing device 102 receives the diverting digital image of the target product 10a including the container ID thereof and automatically compares that container ID to a digital record of anomalous products. The computing device 102 determines that the previously diverted product is non-anomalous and transmits a command signal to the package sorter 118 indicating the same.

In other embodiments, the computing device 102 may be configured to overwrite an anomalous product designation for the diverted target product with a non-anomalous designation. For example, following the repair and reintroduction of an anomalous product, the local computing device 102a may again determine via the trained machine learning model that the product is anomalous (e.g., such determination may be made by mis-identifying a repair as an anomaly). In such instances, the local device 102a is configured to automatically overwrite that determination (e.g., based on the product having gone to and returned from a triage location) with one indicating that the target product 10a is non-anomalous and transmit a command signal to the package sorter 118 to direct the target product 10a to the shipping lane 14. Automatically directing target products that were previously determined to be anomalous to the shipping lane may prevent products from being repeatedly diverted from the shipping lane by the system 100.

In some embodiments, the system 100 is configured to divert products based on a determined confidence score. Such as discussed above with regards to FIG. 3, the trained ML model may be configured to determine a confidence score representative of the severity of anomalies present on a target product 10a and/or the lack of anomalies present on the target product 10a. In some embodiments, the computing device 102 is configured to divert products from the shipping lane 14 based on a confidence score limit. Products having a determined confidence score below the limit may be directed to a shipping lane 14 by the system 100. Products having a confidence score equal to or greater than the limit may be automatically diverted from the shipping lane 14. For example, the confidence score limit may be a 95% anomaly value. A target product 10a determined to be anomalous and having a confidence score of 94% by the trained ML model may be directed to the shipping lane 14. Continuing from the above example, a target product 10a having a determined confidence score of 95% anomaly may be diverted from the shipping lane 14 in generally the same manner as described above.

The computing device 102 may be configured to receive a confidence score limit value and automatically direct products accordingly. By directing products to and away from the shipping lane 14 according to the confidence score the system 100 may enable users to dictate what severity of anomalies present on a product require triage prior to shipping and what is an acceptable severity of anomalies. This may prevent products that are suitable for a user or organizations standards from being diverted from a shipping lane even though the trained ML model may determine a product to be anomalous.

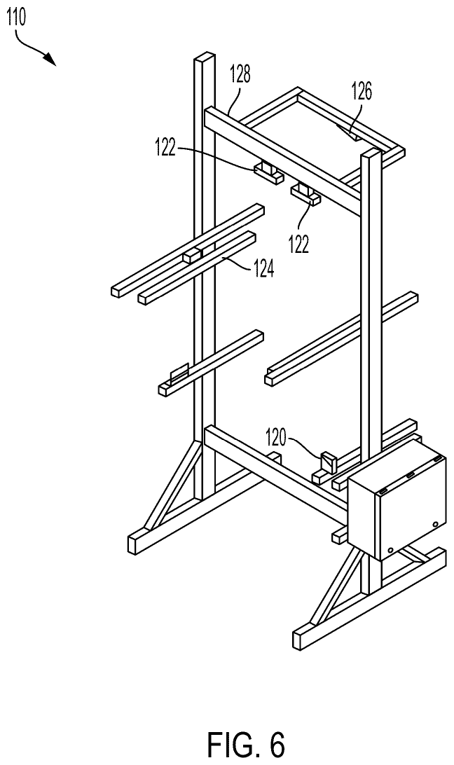

Referring to FIG. 6, the image capture device 110 may include one or more cameras 122 (e.g., single lens camera, 2-dimensional camera), illumination devices 124, barcode scanners 126, package sensors 120, and/or mounting hardware 128 for use with the conveyor system 108. The mounting hardware 128 may be configured to be coupled to a conveyor belt included in the conveyor system 108. For example, the mounting hardware 128 may include mounting brackets configured to be coupled to support members of a conveyor belt. In some embodiments, the package sensor 120 may be coupled to, or located proximate the mounting brackets used to couple the mounting hardware 128 to the conveyor belt. For example, the package sensor 120 may be coupled to the mounting hardware 128 near a conveyor belt such that products transported along the conveyor belt may be detected by the package sensor 120. In other embodiments, the mounting hardware 128 may be configured to position the components of the image capture device 110 relative to a conveyor belt while not being directly coupled thereto. For example, the mounting hardware 128 may not directly contact a conveyor belt included in the conveyor system 108.

The cameras 122 may be configured to capture digital images of products transported along the conveyor system 108 as discussed above. In some embodiments, the cameras 122 are coupled to the mounting hardware 128 and fixed in position relative to the conveyor system 108. In some embodiments, the cameras 122 are detachable from the mounting hardware 128 such that they may be removed for repairs or realignment. In some embodiments, the cameras 122 are configured to be coupled to the mounting hardware 128 in a plurality of different locations. The barcode scanner 126 may be configured to capture a container ID of a product transported along the conveyor system as discussed above, for example. In some embodiments, the barcode scanner 126 is coupled to the mounting hardware 128 in generally the same manner as the cameras 122.

The illumination device(s) 124 may be configured to emit light in the presence of a product to ensure that the cameras 122 are able to generate suitable digital images. For example, digital images captured in dim lighting may result in the trained ML model failing to identify anomalies and/or causing the trained ML model to falsely identify anomalies. In some instances, the illumination device 124 continuously emits light. In other embodiments, the illumination device 124 emits light in response to the package sensor 120 detecting the presence of a product. In some embodiments, the illumination device(s) 124 are oriented relative to the conveyor belt of the conveyor system 108 such that light emitted therefrom is not reflected back into the cameras 122. For example, products transported along the conveyor belt may include reflective surfaces or elements such as, but not limited to, tape and labels. The illumination device(s) 124 may be oriented relative to a top planar surface of the conveyor belt such that the light emitted therefrom does not reflect off of those reflective surfaces into the image capture devices 122. In some embodiments, the illumination device(s) 124 may be oriented such that an angle of incidence of the light emitted therefrom relative to the conveyor belt is between about 10° to about 20°. In some embodiments, the angle of incidence is about 15°.

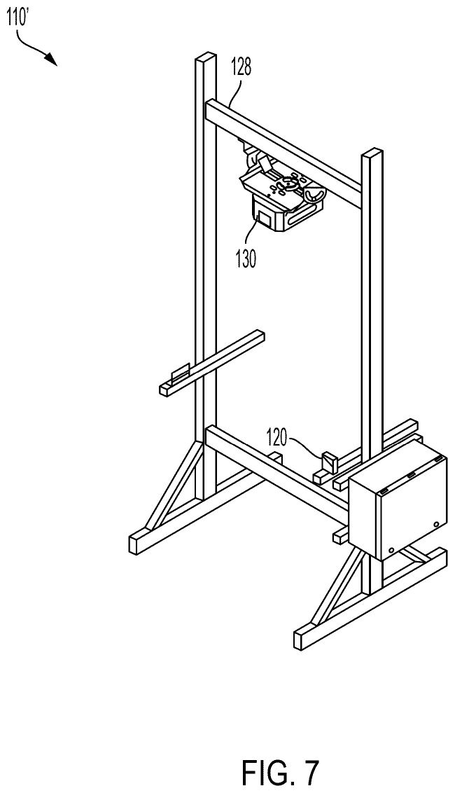

Referring to FIG. 7, there is shown another embodiment of an image capture device, generally designated 110′, in accordance with an exemplary embodiment of the present disclosure. The image capture device 110′ may be generally the same as the image capture device 110 described above with regards to FIGS. 5-6, except that the cameras 122, illumination device(s) 124, and/or barcode scanner 126 may be included in a single capture device 130. The capture device 130 may include a housing containing cameras, illumination device(s), and/or barcode scanners that are generally the same as those discussed above. In some embodiments, the capture device 130 is coupled to the mounting hardware 128 and in communication with the package sensor 120 in generally the same manner as discussed above, for example.

Referring to FIG. 8, there is shown a use case example of an anomalous product diverted from a shipping lane by the system 100. In FIG. 8 a target product 10a is transported along the conveyor system 108 to the image capture device 110 in generally the same manner as discussed above. The image capture device 110 generates a digital image 30 of the target product 10a and transmits the digital image 30 to the local device 102a. The local device 102a receives the digital image 30 and determines whether the target product 10a is anomalous via the trained ML model. As illustrated in the ML model analyzed image 30′, the trained ML model identifies a dunnage leak anomaly, defective seal anomaly, a package deformation anomaly, and a missing label anomaly. The identified dunnage leak anomaly and package deformation anomalies are illustrated in the digital image 30′ as the areas within the broken lines respectively. The trained ML model further determines a confidence score for the digital image 30, which in this example is a 95% anomaly confidence score. The confidence score level threshold in this example is 95% resulting in the local device 102a determining that the target product 10a is to be diverted from a shipping lane. Further to this example, the local device 102a generates a command signal indicating the same and transmits it to the package sorter 118 causing the package sorter to divert the target product 10a from the shipping lane and to a triage location 12.

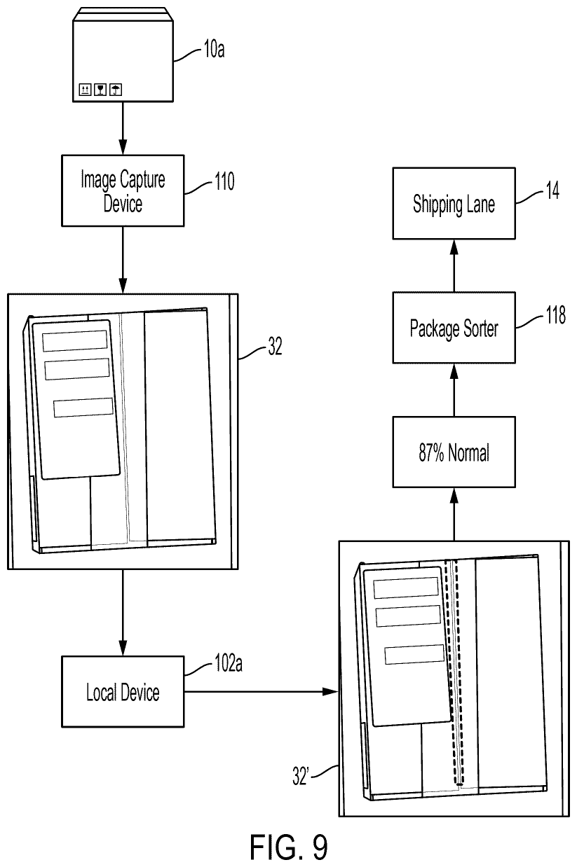

Referring to FIG. 9 there is shown a use case example of a non-anomalous product directed to a shipping lane by the system 100. In FIG. 9 the target product 10a is transported along the conveyor system 108 to the image capture device 110, which generates the digital image 32 of the target product 10a, in generally the same manner as discussed above. The local device 102a executes the trained ML model on the digital image 32 and identifies a container gap anomaly as illustrated in dotted lines appearing the digital image 32′. The trained ML model does not identify any additional anomalies in the digital image 32 and proceeds to calculate the confidence score. In this example, the determined confidence score is 87% normal indicating that although the container gap anomaly was identified, the severity of that anomaly was determined to be low and the target product 10a is 87% likely to be correctly assigned as a non-anomalous product. Based on the 87% normal confidence score, the local device 102a delivers a command signal to the package sorter 118 to direct the target product 10a to the shipping lane 14.

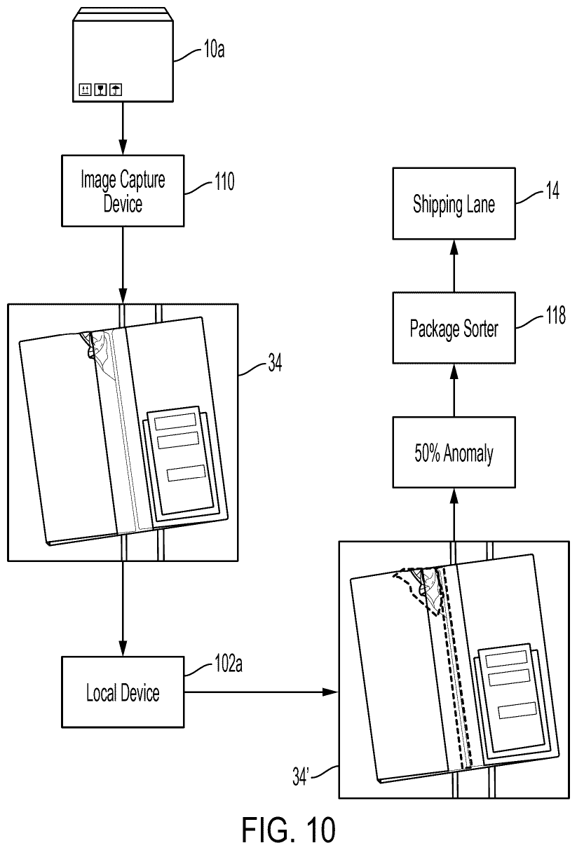

Referring to FIG. 10, there is shown a use case example of the system 100 routing a target product determined to be anomalous but being below a predetermined confidence score threshold. In FIG. 10, the target product 10a travels along the conveyor system 108 to the image capture device 110, which generates the digital image 34 of the target product 10a. The local device 102a executes the trained ML model on the digital image 34 to identify anomalies. In this example, the identified anomalies include a package deformation anomaly and a container gap anomaly as outlined in the broken lines illustrated in the ML model analyzed digital image 34′. The trained ML model determines that the target product 10a is anomalous with a 50% anomaly confidence score. Because, in this example, the confidence score threshold may be set to 95% anomaly, and the target product 10a is determined to have a 50% anomaly confidence score, the local device 102a delivers a command signal to the package sorter 118 to direct the target product 10a to the shipping lane 14 and thus forgo any corrective action.

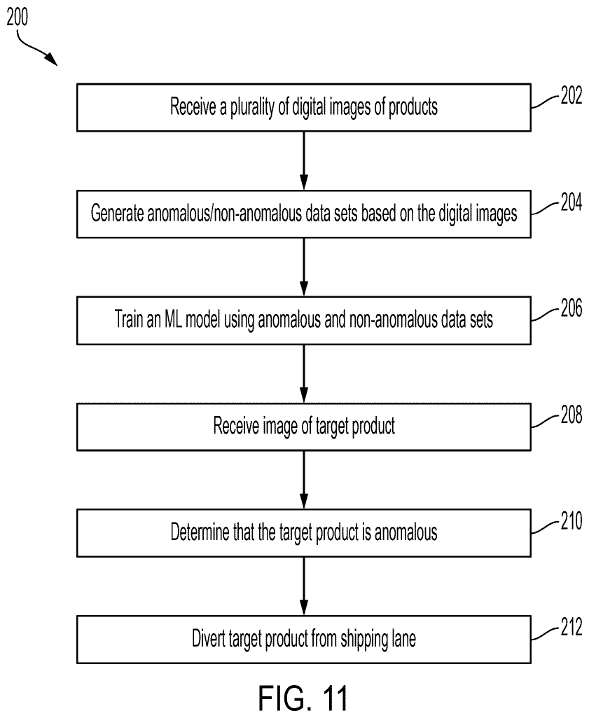

Referring to FIG. 11, there is shown a flowchart illustrating a method of automatically diverting products from a shipping lane, generally designated 200 and referred to as method 200, in accordance with an exemplary embodiment of the present disclosure. In some embodiments, the method 200 may include the step of receiving a plurality of digital images of products. For example, the computing device 102 (e.g., remote computing device 102b) may receive a plurality of digital images 20a, 20b of anomalous and non-anomalous products as discussed above with reference to FIG. 2, for example. The method 200 may include the step 204 of generating an anomalous data set and a non-anomalous data set, based on the plurality of digital images. For example, and as discussed above, for example, the computing device 102b may generate a non-anomalous data set based on the plurality of digital images 20a of non-anomalous products, and an anomalous data set based on the plurality of digital images 20b.

The method 200 may include the step of training a machine learning model using the anomalous data set and the non-anomalous data set. For example, and as discussed above with reference to FIG. 2, the remote device 102b may be configured to train the ML model based on the anomalous and non-anomalous product data sets. In some embodiments, the trained ML model is configured to determine if products are anomalous or non-anomalous. The method 200 may include the step 208 of receiving a digital image of a target product traveling on a conveyor system. For example, and as discussed above with regards to FIGS. 4-5, the image capture device 110 may generate a digital image of a target product 10a in response to the package sensor 120 detecting the target product 10a. The image capture device 110 may be configured to transmit the digital image of the target product 10a, as well as, in some instances, a container ID of the target product 10a, to the local device 102a.

In some embodiments, the method 200 may include the step 210 of, prior to the target product reaching a package sorter, determining, via the trained machine learning model, that the target product is anomalous. For example, the computing device 102 (e.g., the local device 102a) may be configured to receive the digital image of the target product 10a and execute the trained machine learning model on the digital image. In some instances, the trained machine learning model may determine that the target product 10a is anomalous before the target product 10a arrives at the package sorter 118 located downstream of the image capture device 110. The method may include the step 212 of delivering a command signal to the package sorter to cause the package sorter to divert the anomalous product from the shipping lane. For example, in response to the trained ML model determining the target product 10a is anomalous, the computing device 102 may transmit a command signal to the package sorter 118 to cause the package sorter 118 to divert the target product 10a from the shipping lane 14 and to a triage location 12.

In some embodiments, the method 200 may include causing a conveyor gapper to cooperate with the image capture device to ensure that the digital image of the target product does not reflect an adjacent package. For example, and as discussed above, the conveyor gapper 116 may be configured to space a target product 10a from an adjacent product prior to the target product reaching the image capture device 110. The conveyor gapper 116 may cause the target product 10a to be spaced from an adjacent product by a sufficient distance such that at the time that the target product 10a reaches the image capture device, the digital image generated therefrom does not include a depiction of any other product or package traveling along the conveyor system. In some embodiments, the conveyor gapper 116 is configured to gap a target product 10a from an adjacent product by a distance greater than or equal to the length of a largest known product size. For example, and as discussed above, products transported along the conveyor system 118 may be one of a plurality of different predetermined sizes. The conveyor gapper 116 may be configured to space products by a distance that is at least equal to the greatest length of the predetermined sizes. In some embodiments, the conveyor gapper 116 is configured to space each product transported thereto from an adjacent product by the same distance regardless of the size of the product. In other embodiments, the conveyor gapper 116 is configured to space each product transported thereto from an adjacent product by a distance that is equal to a size of the product or the adjacent product.

In some embodiments, the method 200 includes calculating a confidence score representative of a severity of anomalies present on the target product. For example, and as discussed above with reference to FIG. 3, for example, the trained ML model may be configured to calculate a confidence score for digital images based on the number, size and/or type of anomalies identified by the trained ML model. In some embodiments, the method 200 includes calculating a confidence score representative of a lack of anomalies present on the target product. For example, and as discussed above with reference to FIG. 3, the trained ML model may be configured to calculate a confidence score (e.g., 50% normal, 100% normal) based on the lack of anomalies identified in a digital image.

In some embodiments, the method 200 includes receiving from the image capture device a digital image of a second target product. For example, another target product different from a preceding target product may be transported along the conveyor system 108 to the image capture device 110 where a digital image of that target product is generated in the same or similar manner as discussed above. In some embodiments, the method 200 includes prior to the second target product reaching the package sorter, determining, via the trained machine learning model, that the second target product is a non-anomalous product and delivering a command signal to the package sorter to cause the package sorter to direct the non-anomalous product to the shipping lane. For example, the computing device 102 may be configured to receive the digital image of the second target product and determine whether that product is anomalous or not in generally the same manner as discussed above, for example. In an instance where the trained ML model determines the second target product is non-anomalous, the computing device 102 may be configured to transmit a command signal to the package sorter 118 causing the package sorter 118 to direct the second target product to the shipping lane 14.

In some embodiments, the method 200 includes, after diverting the target product from the shipping lane, receiving a diverting digital image of the target product and delivering a command signal to the package sorter to cause the package sorter to direct the target product to the shipping lane. For example, and as discussed above with reference to FIGS. 4-5, the computing device 102 may be configured to automatically direct products previously identified as anomalous and diverted from the shipping lane 14 to the shipping lane in response to a digital image of that product being generated again at the image capture device 110. In some instances, after diverting the target product from the shipping lane, the method 200 includes transporting the diverted target product to a position upstream of the package sorter. For example, a diverted target product 10a may be directed to a triage location 12 that is upstream of the package sorter 118. The system 100 may cause the diverted target product 10a is reintroduced into the main conveyor belt such that the image capture device 110 generates a second digital image of that product. The method 200 may further include overwriting an anomalous product designation for that product with a non-anomalous designation. For example, the second digital image of the target product may be determined to be anomalous by the trained ML model, however the computing device 102 may be configured to determine that the target product 10a was previously diverted and overwrite that determination such that the target product 10a is directed to the shipping lane.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A method of automatically diverting products from a shipping lane on a package conveyor system using a package sorter, the method comprising:
at one or more computing devices communicatively coupled to a network:
receiving a plurality of digital images of products;
based on the plurality of digital images, generating an anomalous data set and a non-anomalous data set;
training a machine learning model using the anomalous data set and the non-anomalous data set;
receiving from an image capture device a digital image of a target product traveling on the conveyor system;
prior to the target product reaching the package sorter, determining, via the trained machine learning model, that the target product is an anomalous product; and
delivering a command signal to the package sorter to cause the package sorter to divert the anomalous product from the shipping lane.

2. The method of claim 1, wherein the conveyor system further includes a conveyor gapper and the method further comprises:
causing the conveyor gapper to cooperate with the image capture device to ensure that the digital image of the target product does not reflect an adjacent package.

3. The method of claim 1, wherein the one or more computing devices includes a local computing device coupled through a local area network to the image capture device and a remote computing device coupled through a wide area network to the local computing device and wherein the determining, via the trained machine learning model is performed at the local computing device and the training the machine learning model is performed at the remote computing device.

4. The method of claim 1, wherein determining that target product is an anomalous product occurs in a timeframe of: a) less than about 2 seconds from the target product reaching the package sorter along the conveyor; b) less than about 5 seconds from the target product reaching the package sorter along the conveyor; c) from about 2 seconds to about 5 seconds of the target product reaching the package sorter along the conveyor system; d) from about 1 second to about 2 seconds of the target product reaching the package sorter along the conveyor system; or e) less than about 1 second from the target product reaching the package sorter along the conveyor.

5. The method of claim 1, wherein determining the target product is an anomalous product further includes calculating a confidence score representative of a severity of anomalies present on the target product.

6. The method of claim 1, further comprising:
after diverting the target product from the shipping lane, receiving at the computing device a diverting digital image of the target product; and
delivering a command signal to the package sorter to cause the package sorter to direct the target product to the shipping lane.

7. The method of claim 1, further comprising:
receiving from the image capture device a digital image of a second target product;
prior to the second target product reaching the package sorter, determining, via the trained machine learning model, that the second target product is a non-anomalous product; and
delivering a command signal to the package sorter to cause the package sorter to direct the non-anomalous product to the shipping lane.

8. The method of claim 7 further comprising:
calculating a confidence score representative of a lack of anomalies present on the second target product.

9. The method of claim 1 wherein the anomalous product is characterized by defective seal.

10. The method of claim 1 wherein the image capture device is configured to scan the target product for a container ID and capture the digital image of the target product for determining an anomaly status of the target product.

11. The method of claim 1 further comprising:
after diverting the target product from the shipping lane, transporting the diverted target product to a position upstream of the package sorter along the package conveyor system;
causing the image capture device to scan the diverted target product; and
overwriting an anomalous product designation for the diverted target product with a non-anomalous designation.

12. A system for automatically diverting products from a shipping lane, the system comprising:
a package conveyor system including a shipping lane downstream of a package sorter, the package conveyor configured to transport products to the package sorter; and
one or more computing devices communicatively coupled to a network, the one or more computing devices configured to:
receive a plurality of digital images of products;
based on the plurality of digital images, generate an anomalous data set and a non-anomalous data set;
train a machine learning model using the anomalous data set and the non-anomalous data set;
receive from an image capture device a digital image of a target product traveling on the conveyor system;
prior to the target product reaching the package sorter, determine, via the trained machine learning model, that the target product is an anomalous product; and
deliver a command signal to the package sorter to cause the package sorter to divert the anomalous product from the shipping lane.

13. The system of claim 12, wherein the conveyor system further includes a conveyor gapper and the one or more computing devices are configured to:
cause the conveyor gapper to cooperate with the image capture device to ensure that the digital image of the target product does not reflect an adjacent package.

14. The system of claim 12, wherein the one or more computing devices includes a local computing device coupled through a local area network to the image capture device and a remote computing device coupled through a wide area network to the local computing device and wherein the local device is configured to determine, via the trained machine learning model that the target product is an anomalous product and the remote computing device is configured to train the machine learning model.

15. The system of claim 12, wherein the one or more computing devices are configured to determine that target product is an anomalous product within a timeframe of: a) less than about 2 seconds from the target product reaching the package sorter along the conveyor; b) less than about 5 seconds from the target product reaching the package sorter along the conveyor; c) from about 2 seconds to about 5 seconds of the target product reaching the package sorter along the conveyor system; d) from about 1 second to about 2 seconds of the target product reaching the package sorter along the conveyor system; or e) less than about 1 second from the target product reaching the package sorter along the conveyor

16. The system of claim 12, wherein the one or more computing devices are further configured to calculate a confidence score representative of a severity of anomalies present on the target product.

17. The system of claim 12, wherein the one or more computing devices are further configured to:
after diverting the target product from the shipping lane, receive at the computing device a diverting digital image of the target product; and
deliver a command signal to the package sorter to cause the package sorter to direct the target product to the shipping lane.

18. The system of claim 12, wherein the one or more computing devices are further configured to:
receive from the image capture device a digital image of a second target product;
prior to the second target product reaching the package sorter, determine, via the trained machine learning model, that the second target product is a non-anomalous product; and
deliver a command signal to the package sorter to cause the package sorter to direct the non-anomalous product to the shipping lane.

19. The system of claim 18, wherein the one or more computing devices are further configured to:
calculate a confidence score representative of a lack of anomalies present on the second target product.

20. The system of claim 12, wherein the anomalous product is characterized by defective seal.

21. The system of claim 12, wherein the image capture device is configured to scan the target product for a container ID and capture the digital image of the target product for determining an anomaly status of the target product.

22. The system of claim 12, wherein the one or more computing devices are further configured to:
after diverting the target product from the shipping lane, transport the diverted target product to a position upstream of the package sorter along the package conveyor system;
cause the image capture device to scan the diverted target product; and
overwrite an anomalous product designation for the diverted target product with a non-anomalous designation.
